(19) United States
(12) Patent Application Publication
(10) Pub. No.: US 2025/0046932 A1
(43) Pub. Date: Feb. 6, 2025

(54) STRUCTURAL COMPOSITES FOR BATTERY ENCLOSURE

(71) Applicant: BRIDGESTONE AMERICAS, INC., Nashville, TN (US)

(72) Inventors: Mark W. Brandley, Nashville, TN (US); Denis Schmitz, Munchen (DE); Inigo Echeto, Munchen (DE); Markus Freiberger, Munchen (DE); Adam J. Halsband, Munchen (DE); Paul M. Hannibal, Munchen (DE)

(21) Appl. No.: 18/719,537

(22) PCT Filed: Dec. 13, 2022
(86) PCT No.: PCT/US2022/081443

§ 371 Date: Jun. 13, 2024

Related U.S. Application Data
(60) Provisional application No. 63/290,330, filed on Dec. 16, 2021.

(51) Int. Cl. H01M 50/242; H01M 50/231; H01M 50/262; H01M 50/282

(52) U.S. Cl. CPC H01M 50/242; H01M 50/231; H01M 50/262; H01M 50/282; H01M 2220/20

(57) ABSTRACT

A molded composite battery enclosure containing top and bottom composite covers attached together. The joined top and bottom composite cover structures form an enclose or open area for housing a battery system of battery cells and cooling devices. The composite battery enclosures are lightweight and made of materials that can function to absorb energy and insulate the battery housing area. The composite structures contain a core material adhered and sandwiched between fiber layers with monolithic flange sections for improved fitting of the covers.

### TECHNICAL FIELD

The present disclosure relates to modular structural composites for use as battery enclosures and, in particular, to structural composites having interlocking components for use as a battery enclosure for electric vehicles or equipment.

### BACKGROUND

Vehicles powered by electric batteries have grown in popularity with users. These vehicles allow a user the ability to charge the batteries at their place of residence or at a charging station and avoid the cost of purchasing gasoline. To supply the power needed to reach long distances, these vehicles need large capacity batteries. However, these large capacity batteries pose an increased risk to occupants and emergency responders if the batteries are damaged during a collision. The batteries need to be protected from the force generated during the collision or alternatively, any force transmitted to the batteries must be low enough so as not to cause significant damage to the batteries.

The present disclosure provides battery enclosures that are strong and light weight, as compared to battery enclosures known heretofore. The enclosures utilize composite materials, optionally with monolithic features, to protect the batteries from significant damage during a collision and assist in the assembly of the enclosures during manufacturing. The composite materials and monolithic features provide a medium for selectively improving the performance of intersecting components of a multi-component battery enclosure.

### SUMMARY

In a first aspect, disclosed is a composite battery enclosure that includes a molded top composite cover having a first monolithic flange section at the perimeter of the molded top composite cover, the first monolithic flange section having fibers embedded in a first polymer, the first monolithic flange section further having a first surface and a second surface, and a first core positioned adjacent the first monolithic flange section, the first core sandwiched between a first top composite cover skin and a second top composite cover skin; and a molded bottom composite cover having a second monolithic flange section at the perimeter of the molded bottom composite cover, the second monolithic flange section made from fibers embedded in a second polymer, the second monolithic flange section also having a first surface and a second surface, and a second core positioned adjacent the second monolithic flange section, the second core sandwiched between a first bottom composite cover skin and a second bottom composite cover skin.

In a second aspect, there is a composite battery enclosure that includes a molded bottom composite cover having a second core sandwiched between a first bottom composite cover skin and a second bottom composite cover skin; the second core forming a sidewall of the enclosure, the sidewall having an interior sidewall surface, a top sidewall surface, and an outer sidewall surface, and a molded top composite cover having a first core sandwiched between a first top composite cover skin and a second top composite cover skin, the first core includes a reinforced area of increased thickness positioned adjacent the sidewall formed by the second core of the molded bottom composite cover such that the reinforced area of increased thickness abuts against a portion of interior sidewall surface of the molded bottom composite cover and along the interface of the interior sidewall surface and top sidewall surface.

In a third aspect, there is a composite battery enclosure that includes a molded top composite cover having a first core sandwiched between a first top composite cover skin and a second top composite cover skin, the first core having a top portion and a sidewall portion, the sidewall portion of the molded top composite cover having a top composite cover perimeter surface; a molded bottom composite cover with a second core sandwiched between a first bottom composite cover skin and a second bottom composite cover skin, the second core having a top portion and a sidewall portion, the sidewall portion of the molded bottom composite cover having a bottom composite cover perimeter surface, the bottom composite cover perimeter surface facing the top composite cover perimeter surface; and an interface in the sidewall of the composite battery enclosure, the interface formed by the sidewall portion of the top composite cover meeting the sidewall portion of the bottom composite cover, wherein the interface has a first section and a second section, the first section having an interface angle different than an interface angle of the second section.

Any one of the above aspects (or examples of those aspects) may be provided alone or in combination with any one or more of the examples of that aspect discussed above; e.g., the first aspect may be provided alone or in combination with any one or more of the examples of the first aspect discussed above; and the second aspect may be provided alone or in combination with any one or more of the examples of the second aspect discussed above; and so-forth.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiments, and together with the description serve to explain principles and operation of the various embodiments. Directional terms as used herein—for example, up, down, right, left, front, back, top, bottom—are made only with reference to the figures as drawn and are not intended to imply absolute orientation.

### BRIEF DESCRIPTION OF THE DRAWINGS

The above and other features, examples and advantages of aspects or examples of the present disclosure are better understood when the following detailed description is read with reference to the accompanying drawings, in which:

FIG. 1 shows a cross-section view of a two-piece battery enclosure including a molded upper composite cover and a molded bottom composite cover with a battery retaining area.

FIG. 2 shows a cross-section view of a portion of the two-piece battery enclosure of FIG. 1 having the molded upper composite cover in contact with the molded bottom composite cover.

FIG. 3 shows a cross-section view of a two-piece battery enclosure including a molded upper composite cover and a molded bottom composite cover with a battery retaining area.

FIG. 4 shows a cross-section view of a portion of the two-piece battery enclosure of FIG. 3 having the molded upper composite cover in contact with the molded bottom composite cover.

### DETAILED DESCRIPTION

The terminology as set forth herein is for description of the embodiments only and should not be construed as limiting the invention as a whole.

Herein, when a range such as 5-25 (or 5 to 25) is given, this means preferably at least or more than 5 and, separately and independently, preferably less than or not more than 25. In an example, such a range defines independently 5 or more, and separately and independently, 25 or less.

The terms “substantial,” “substantially,” and variations thereof as used herein are intended to note that a described feature is equal or approximately equal to a value or description. For example, a “substantially planar” surface is intended to denote a surface that is planar or approximately planar. It also is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

The present disclosure relates to composite battery enclosures that can be used in a variety of applications. For example, the composite battery enclosures can be used to house battery systems and related accessories for mechanical equipment and in automotive applications (e.g., passenger vehicle, car, truck, bus, tractor, all-terrain vehicle). In some embodiments, the composite battery enclosure can house a battery system for electric and hybrid vehicles. The composite battery enclosure can be modular and contain multiple pieces connected or attached to one another to form a complete enclosure or box.

The composite battery enclosures can generally have increased global stiffness that resists bending and torsion of the structure and are relatively lightweight. In one or more embodiments, the composite battery enclosures can have connection or attachment areas between the top and bottom covers to provide crash strength and integrity. The composite battery enclosures can have a cover with a multi-thickness composite structure attributing to improved assembly of the enclosure and increased lateral stiffness of the enclosure. In another example, the composite battery enclosures can have multiple monolithic sections that contact one another to further contribute to improved assembly and lateral stiffness of the enclosure.

In yet another example, the composite battery enclosures can have one or more modified connection points along sidewalls of the enclosure. Top and bottom covers can meet along a point of the sidewall of the battery enclosure to join and seal the enclosure. This connection point can include an interlocking geometry to improve stiffness and resistance to impact. The interlocking geometry of the connection point can further prevent or reduce the entrance of undesirable materials into the internal chamber of the battery enclosure, for instance, dust, debris, moisture, gases, etc.

Other advantages of the composite battery enclosure covers and connection points are that they include being easily formable into a desirable shape by conventional molding methods that preferably use low or moderate pressure and heat, which advantageously lowers time and cost to manufacture the structures.

The individual composite components can be attached to one another by conventional methods, for example, using an adhesive or epoxy, a fastener (e.g., screw, bolt, clip), welding, a sealing material, or a combination thereof. For a chemical bond or attachment means between composite components of the battery enclosure, any suitable adhesive can be used, for example, an epoxy. The adhesive can be applied to an outer surface of a composite cover, such as an exposed surface of fiber layer or an outer perimeter flange section. It is preferable that the composite covers are permanently attached to one another to ensure structural integrity of the modular composite structure during use. Other fasteners or attachment fixtures can be used in place of an adhesive, for example, a screw, snap fitting, rivet, clamp, bolt or clip. Additional local inserts or onserts can be provided at attachment locations to provide increased stiffness beyond that provided by the improved connection points of the top and bottom covers of the battery enclosure.

The individual composite structures of the battery enclosure, such as a molded bottom and top composite cover, can have similar components that can be made of the same or similar materials. For example, the composite covers can have a fiber-containing layer at least partially adhered to a core structure or material, which can optionally have a select multi-thickness or regions therein, for example, at or near the connection point between the covers. The fiber layers of various individual composite covers can be made of the same or similar materials to reduce material and manufacturing costs. Similarly, when recycled materials can be substituted, for example, for fibers in the fiber layers, such materials can be used to further reduce manufacturing costs and promote sustainability.

One or more embodiments further include methods for fabricating and manufacturing individual and modular composite battery enclosures. For example, a fiber layer can be positioned or applied on a surface or multiple surfaces of a core material (e.g., a first surface) to form a blank. A second fiber layer can be positioned on a second surface of the core material. Attachment devices can optionally be positioned below or on the fiber layers, for example, in cut out areas in the fiber layers. A curable material (e.g., resin) can be sprayed, poured, spread, rolled, brushed or calendared onto the fiber layers and reinforcement fibers to coat and embed the fibers in the curable material to form a pre-form composite. Under heated conditions, the pre-form composite can be molded (e.g., in a compression or press mold or similar tooling) to form the final shape of the composite battery enclosure.

Molding conditions such as temperature and pressure can be adjusted as needed but are preferably low to moderate to reduce time and cost of manufacturing the composite battery enclosure. For example, the enclosure can be heated during molding to a temperature in the range of about 100° to about 200° C., about 110° to about 190° C., about 120° to about 180° C., or about 130° to about 160° C. In another example, the enclosure can be subjected to pressure during molding in a range of about 0.1 megapascal (MPa) to about 1 MPa, about 0.15 to about 0.8 MPa, or about 0.2 to about 0.6 MPa.

The molding process can form areas of varying thickness in the composite battery enclosure that selectively increase or reduce thickness of the core material, for instance, near a connection point, at a bend area or to form a recess, indentation, channel or groove. In the embodiments that include a honeycomb as the core material, sections of the honeycomb core can be crushed or partially crushed where thickness is reduced (e.g., at corners, edges, transition areas, recesses, channels, etc.). In one or more embodiments, it is desirable to utilize a thermoplastic material (e.g., polycarbonate) as the core material. For example, a thermoplastic core material can be melted under heated mold conditions and varying thickness can be achieved without changing the integrity of the material.

In some embodiments, the fiber layers or skins can extend past the core material and join together to form flanges void of any composite material therebetween, for example, at the perimeter of the top and bottom covers. These multilayer sections (e.g., two fiber skins ajoined together) can be referred to as a monolithic portion or section as opposed to a sandwich composite that contains a core material between two fiber layers. These monolithic flanges can be formed in the molding process to any desired shape to align the flanges together, for example, to nest them together. The aligned monolithic flange portions of the covers can assist in assembly and alignment of the covers together in addition to providing additional stiffness and resistance to movement of the covers relative to one another.

In one or more embodiments, the composite battery enclosure (e.g., molded covers joined together) can be trimmed and polished after being molded to remove any undesirable surface imperfections, for example, a burr or raised edge or piece of material left on the structure before coupling to another battery enclosure composite piece. Burrs or imperfections can be manually or mechanically removed, for instance, mechanically grinding or sanding the surface of the composite cover. Subsequent to a trimming step, if needed, the composite covers can be cleaned to remove debris or any excess material from the surface. Cleaning can be carried out with conventional methods, for example, pressurized gas or air can be blown on the composite covers to dislodge debris, such as dust or particles, that is adhered to the surface. The composite covers can also be brushed or wiped to remove unwanted material. In another example, the covers can be brought into contact with a cleaning solution, which can dissolve residue (e.g., release agents) from the surface of the cover. For instance, an aqueous solution with a cleaning agent (e.g., a surfactant) can be used. A cleaning solution can applied to the surface of the composite covers by any suitable method such as spraying, dipping or brushing.

The steps of trimming and cleaning prepare the composite battery enclosure for downstream processes if desired. In some embodiments, the composite battery enclosure can have additional coatings applied to its surface, such as an overcoat or protective coating (a fire, smoke and toxicity (FST) material, fire-retardant material or resin). In other embodiments, the composite battery enclosure can be painted for its final application, for example, installation in an electric or hybrid vehicle.

Assembly of the composite battery enclosure and related components can be carried out by positioning the bottom composite cover and then inserting the desired battery system. Battery cells can be mounted over a cooling system, if present, followed by connection of all electrical cables. If desired, a perimeter seal is positioned on the bottom composite cover before placing the top composite cover over the bottom cover. Attachment means, for instance adhesive or fixtures (e.g., screws), are used to secure the top and bottom composite covers together before mounting the assembled composite battery enclosure in the desired application such as an electric vehicle.

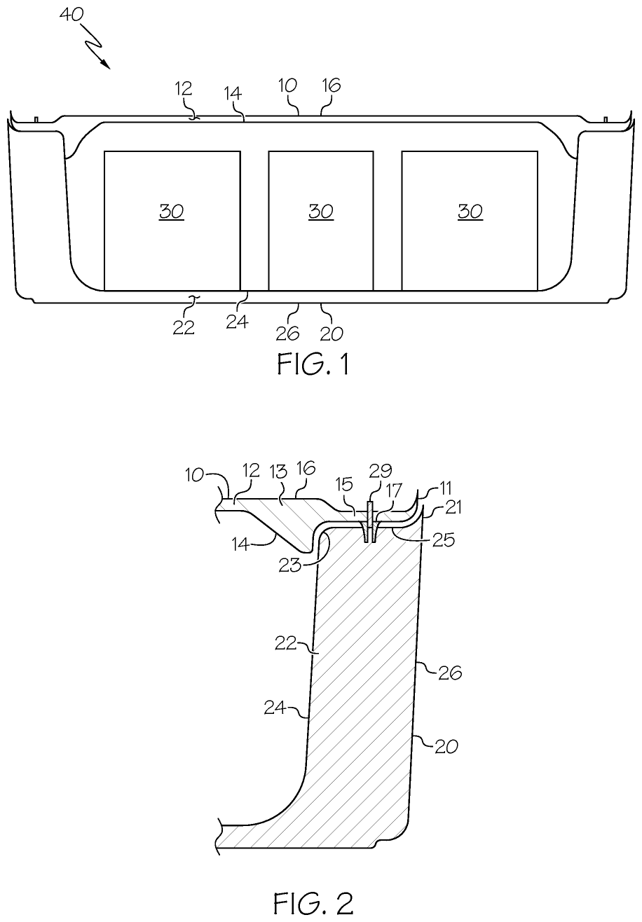

Turning to the figures, FIGS. 1 and 2 show a two-piece composite battery enclosure 40 that includes a molded top composite cover 10 and a molded bottom composite cover 20, which can be attached to one another at an interface area to provide a battery enclosure area. As shown, molded bottom composite cover 20 can be designed to house a battery system including a plurality of batteries 30. Any suitable number of batteries can be included in the battery enclosure 40, for instance, for accommodating an electric vehicle power requirement. Enclosure 40 can be a component of a vehicle such that enclosure 40 is secured to other portions or parts of a vehicle, for example, a frame structure. Top and bottom composite covers 10, 20 have core sections 12, 22 arranged between two skins 14, 16, 24, 26 (e.g., fiber layers). The core sections can extend in a central area of a cover 10, 20 along its entire length as shown and further include portions having an increased in thickness at select regions, for example, along a perimeter edge for providing impact protection, stiffness to the battery enclosure, and resistance to shifting of the covers when contacting a sidewall section of a bottom cover.

Top composite cover 10 has a top skin 16 and a bottom skin 14. As shown in FIGS. 1 and 2, top skin 16 and bottom skin 14 can include a core material sandwiched therebetween and in direct contact with the skins. Bottom composite cover 20 has a top skin 26 and a bottom skin 24, which sandwich core material therebetween that is in direct contact with the skins. In one or more embodiments, the skins 14, 16, 24, 26 can be a fiber layer. A fiber layer can contain continuous and/or discontinuous fibers embedded in a polymer material to form layers having a substantially uniform thickness. The fibers can be arranged together to form a sheet or mat that can be positioned on a core material.

The fibers can be entangled in a random pattern or in a more systematic design, for example, the fibers can be unidirectional/aligned or weaved together in the form of a woven fiber sheet. In other examples, the fibers can be loosely bundled together or pressed together into a mat to form a fiber sheet. Multiple layers of unidirectional fibers can be used, for example, each layer of unidirectional fibers can be arranged at a parallel, angled or perpendicular position relative to an underlying fiber layer. A whole fiber sheet can be used to cover a core material surface (e.g., a top surface). Alternatively, strips or sections of fibers can be applied side by side in a segmented arrangement to cover a core material surface. Examples of fibers that can be used in the fiber layer include carbon fibers, glass fibers, plastic fibers, etc. In one example, an inexpensive fiberglass sheet can be applied to a first surface of a core material.

The fibers can be applied to the surface of a core material to cover an entire face surface of the core material or a portion thereof. In some embodiments, the fibers are arranged on a core material, a polymer forming material or resin can be applied onto the fibers. The polymer forming material can penetrate and soak into the fibers arranged on the core material, which can embed or partially embed the fibers in the polymer forming material. As described herein, polymer forming material can be pushed and forced into the fiber layer to embed the fibers during a molding step, for example, a press or compression mold can push polymeric resin into the fibers to coat the fibers, fill voids in the fiber layer and contact the core material. A sufficient amount of polymer forming material can be applied to the fibers to form polymer layer that embeds the fibers and contacts the core material 12, 22 to adhere the fibers to one another and to the core. In one or more embodiments, the polymer can be formed from a curable polymer resin or composition. The composition can include a mixture of components, for example, a thermoset material, a thermoplastic material, a hardener, a catalyst, fillers, and any combination thereof. Materials can include epoxy, polyurethane, polyether ether ketone, polyethylene, or combinations thereof. The composition preferably has a low cure period in the range of 1 to 20 minutes, or less than 15, 10 or 5 minutes. The polymer forming material once cured can bond the fiber layer (e.g., 14, 16, 24, 26) to the core material (e.g., 12, 22) to form a laminate as the composite structure (e.g., 10, 20). The fiber layer preferably bonds or adheres to the core to prevent delamination or separation of the fiber layer from core material.

As applied to a fiber layer or core material, a curable material can be applied onto the fiber reinforcement region or regions if present. The curable material can be the same curable material used to embed the fibers of the fiber layers. For instance, materials can include a mixture of components, for example, a thermoset material, a thermoplastic material, a hardener, a catalyst, fillers, and any combination thereof. Curable materials can include epoxy, polyurethane, polyether ether ketone, polyethylene, or combinations thereof. The curable material (e.g., resin) can be sprayed, poured, spread, rolled, brushed or calendared onto the fiber reinforcement region to embed or the fibers in the curable material to form a pre-form composite. Under heated conditions, the pre-form composite can be molded (e.g., in a compression) mold to form the final shape of the composite structure.

In one or more embodiments, the skins (e.g., fiber material) can extend beyond the surface of a core material to form monolithic sections (e.g., flanges) devoid of core material therebetween. The monolithic sections or flanges herein can have a thickness in the range of about 1 mm to about 5 mm when devoid of core material. In an example, monolithic sections can be combined with second fibers applied to an opposite face surface of the core material or a portion thereof to form a border region, such as a flange or lip at an end area (e.g., a perimeter portion) of a composite cover 10, 20. The monolithic section 11, 21 can be a perimeter border, or a select portion thereof, for the top and bottom composite covers 10, 20. As described below, the monolithic flange section of the top cover can nest in a monolithic flange section of the bottom cover to fit the covers together and provide stability and structural integrity to the enclosure.

As shown in FIG. 2, the skins 14, 16 of top composite cover 10 form a monolithic flange section 11 at the perimeter of the cover. The monolithic flange section 11 is in a curved shape that extends upward relative to the top surface section 25 of the bottom composite cover 20 underlying the top composite cover 10. A portion of the monolithic section 11 is curved upward and perpendicular to the planar horizontal position of the skins at the central portion of the top composite cover 10. The curved monolithic flange section 11 of the top composite cover 10, or a top monolithic section, nests against a complimentary curved monolithic section 21, or a bottom monolithic section, of the bottom composite cover 20. The skins 24, 26 of bottom composite cover 20 form a monolithic section 21 at the perimeter of the cover. The monolithic section 21 is in a curved shape that extends upward relative to the bottom surface section 17 of the top composite cover 10 overlying the bottom composite cover 20. A portion of the monolithic section 21 is curved upward and perpendicular to the planar horizontal position of the skins 24, 26 at the central portion of the bottom composite cover 20.

The curved monolithic sections 11, 21 of the top and bottom composite covers 10, 20 nest together and preferably can directly contact one another. For instance, each monolithic flange section 11, 21 can have a first and second surface such that one of the surfaces of each flange section touch one of the surfaces of the section positioned inside or outside of the other section. The bottom monolithic section 21 underlies the top monolithic section 11 such that lateral movement of the top composite cover 10 is reduced or prevented when the top monolithic section 11 presses against the bottom monolithic section 21 residing outside the perimeter of the top composite cover 10. In addition to reducing movement of the top composite cover 10 relative to the bottom composite cover 20, the nested fitting of the top and bottom monolithic sections 11, 21 desirably accommodates positioning of the top composite cover 10 on the bottom composite cover 20 during assembly.

In one or more embodiments, the top composite cover 10 can include a reinforced area 13 in its core 12. The reinforced area 13 has an increased thickness as compared to an adjacent core section in the top cover 10, for example, a central section positioned over the battery enclosure area and away from the perimeter of the cover 10. The reinforced area 13 having an increased thickness is preferably positioned adjacent a sidewall formed by the bottom composite cover 20. As shown in FIG. 2, the core 22 of the bottom composite cover 20, sandwiched between skins 24, 26, forms a sidewall of the composite battery enclosure. The sidewall extends upward from the base of the bottom composite cover to define an interior battery enclosure region for holding batteries, e.g., 30. The bottom composite cover 20 can have four sidewalls that are connected to form the battery enclosure region. The sidewall has an interior sidewall surface, a portion of skin 24, facing inward to the battery enclosure area, a top sidewall surface 25, and an outer sidewall surface, a portion of skin 26, facing outward to the environment surrounding the battery enclosure.

The top sidewall surface 25 forms a flat upper lip section along the perimeter of the bottom cover 20 for supporting the top composite cover 10 resting thereon. The perimeter region 15 of the top composite cover 10, that includes a portion of core 12 sandwiched between skins 14, 16 and directly adjacent the monolithic flange section 11, rests directly on the top sidewall surface 25 of the bottom composite cover 20. In one or more embodiments, the top composite cover 10 can be attached to the bottom composite cover 20 at perimeter region 15, for example, with a fastener. As shown, a fastener can extend through the perimeter region 15 of the top cover 10, the top sidewall surface 25 and into the core 22 of the sidewall formed by the bottom composite cover 20.

Adjacent the perimeter region or lip section 15 of the top cover 10, the reinforced area of increased thickness 13 abuts against a portion of the interior sidewall surface of the bottom cover 20. In one or more embodiments, the reinforced area of increased thickness 13 cradles the transition area between the interior sidewall surface and the top sidewall surface 25 such that the reinforced area 13 is braced against the interior top corner of the sidewall of the bottom cover 20. The reinforced area of increased thickness 13, having an average and maximum thickness greater than both that of the adjacent core sections of the top cover 10, the central core area and the perimeter region 15, includes a curved section that overlies and nests against the top interior corner surface of the sidewall at the interface of the interior sidewall surface and the top sidewall surface 25. In some embodiments, the maximum thickness of the reinforced area can be 2, 3, 4, 5 or 6 times greater than the average thickness of an adjacent core section, both adjacent core sections, or the average thickness of the remaining core sections of the top composite cover 10.

As reinforced area 13 transitions to the perimeter region 15, the core material 12 is reduced in thickness as it extends along the top sidewall surface 25 towards the monolithic flange 11. That is, the area of increased thickness of the reinforced area 13 ends along a portion of the top sidewall surface. As shown, the reinforced area 13 can have a maximum thickness at or near the position where the reinforced area 13 meets or abuts against the interior sidewall surface directly before the top interior corner of the sidewall. This positioning of the maximum thickness ensures the greatest contact area along the interior sidewall surface for resisting lateral movement of the top composite cover 10 relative to the sidewalls of the bottom composite cover 20. Moving toward the central area of the top composite cover 10 overlying the battery enclosure region, the core 12 tapers to a reduced thickness in the reinforced region 13 before forming the central core area of the top cover 10. In some embodiments, the central core area of the top cover 10, directly adjacent the reinforced area 13, can have a constant thickness as compared to a tapered thickness profile of the reinforced area 13 that leads to a maximum thickness point. In a similar arrangement, the perimeter region 15 can have a constant thickness, aside from the pinched area leading to the transition into the monolithic flange section 11, as compared to a tapered thickness profile of the reinforced area 13.

For the core sections of the covers disclosed herein, for example cores 12, 22 of the individual composite covers, the core material can be a plurality of open or gas-filled cells defined by cell walls. The cells can have any suitable cross-section shape (e.g., circular, hexagon, square, etc.). For example, the cores can be a honeycomb structure that includes many individual open cells side by side and arranged in the composite structures such that the cell walls are perpendicular to the longitudinal axis of the composite structure or an adjacent fiber layer. Alternatively, the cell walls can be arranged at other angles, for example, parallel or angled relative to the longitudinal axis of the composite structure. The cell walls can be made of plastic, for example, a thermoplastic or thermoset material. In one example, polypropylene or polycarbonate can be used as the material for the core and/or cell walls. The plurality of cells can be molded to form a desired shape wherein a portion of the cells are deformed under pressure, and optionally heat, to reduce the initial thickness of the core material.

In one or more embodiments, the cores can be a non-cell material and composed any suitable thermoplastic material. Examples of thermoplastic materials include, but are not limited to, polypropylene and polycarbonate. The thermoplastic core can be a solid structure without openings such as cells. The thermoplastic core material can be molded under moderate heat and pressure to soften the material and form it into the desired shape having varying thickness. In one example, the thermoplastic material is heated above its glass transition temperature in a molding process to form the desired shape of the structure. The thermoplastic material can be heated, for example in a mold, to have a temperature in the range of about 1000 to about 200° C., about 110° to about 190° C., about 120° to about 180° C., or about 130° to about 160° C. After forming the desired structure shape of the core, the thermoplastic material can be cooled to room temperature. In one or more embodiments, the average thickness of the core can be in the range of about 5 to about 250 millimeters (mm), about 5 to about 100 mm, or about 10 to about 50 mm.

The core is preferably easily moldable to arrive at the desired shape for the composite covers. In one or more embodiments, the core can have regions of different thicknesses and angles along its length (e.g., the reinforced area of increased thickness 13). The core material can have properties that provide an energy absorbing and insulating abilities. For example, the core can be a low density, crushable core that deforms upon impact and yet retains mechanical integrity (e.g., stiffness) in normal operation. The open cells and cell walls of a honeycomb core can absorb impact energy as the cell walls collapse and break. Other materials that can absorb energy can include elastomers, thermoplastic material, foams (e.g., open cell, viscoelastic, etc.), paper (e.g., cardboard), or molded resins. These materials can be combined with the plurality of cells, for example, the cells or a portion thereof (e.g., select regions where impact or insulating is desired) can be filled or partially filled with foams or elastomers. In other embodiments, the core material can reduce conductivity as compared to other conventional materials such as steel. In one or more embodiments, the core materials of the composite structures of the present disclosure can include a conducting fiber (e.g., electrical conducting) for providing electromagnetic compatibility properties or behavior of the composite structure. For example, conductive reinforcements (e.g., metal inlay) or conductive wires can be layered in the sandwich composites or woven in fiber layers of the top and bottom composite covers 10, 20. In another example, shielding foil such as aluminum foil or an outer shielding layer such as metal (e.g., copper) veil can be applied to the battery enclosure 40.

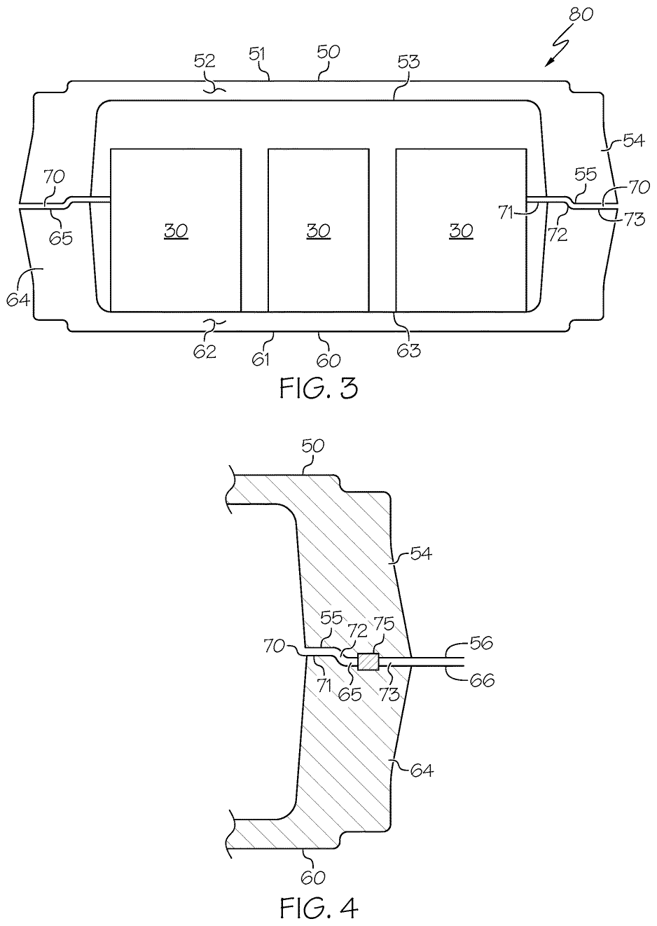

Turning to FIGS. 3 and 4, another embodiment of a composite battery enclosure 80 is shown. The battery enclosure 80 includes a top composite cover 50 and a bottom composite cover 60. The top and bottom composite covers 50, 60 are formed by core material sandwiched between skins as similarly described above for battery enclosure 40. The top composite cover 50 has core material 52 sandwiched between top skin 51 and bottom skin 53 such that the core material directly contacts the skins. Bottom composite cover 60 has a top skin 61 and a bottom skin 63, which sandwiched core material 62 is positioned therebetween and is in direct contact with the skins. In one or more embodiments, the skins 51, 53, 61, 63 can be a fiber layer as described above for skins 14, 16, 24, 26. For example, a fiber layer can contain continuous and/or discontinuous fibers embedded in a polymer material to form layers having a substantially uniform thickness. The fibers can be arranged together to form a sheet or mat that can be positioned on a core material. The core material 52, 62 in the top and bottom composite covers 50, 60 can contain the same core material described above for cores 12, 22.

As shown, the top and bottom composite covers 50, 60 are stacked, the top cover 50 overlying the bottom cover 60, to form a battery enclosure area for storing a plurality of battery units 30. In some embodiments, the top and bottom cover 50, 60 can be identical in dimensions and shape aside from an interface surface where the two covers meet, which can be mirror images of one another for forming an interlocking interface. Thickness of the bottom and top composite covers 50, 60, and those covers of FIGS. 1 and 2, can range from about 10 to about 40 mm across the various components and regions in the covers containing a core material. Forming the skins, core and composite covers can be achieved as described above for the battery enclosure of FIGS. 1 and 2.

The top composite cover 50 includes a top section or portion that forms the central top surface of the battery enclosure. A portion of the sidewalls of the battery enclosure are formed by the sidewall section 54 of the top composite cover 50. In one or more embodiments, the battery enclosure 80 can be in the shape of a square or rectangular box such that the top composite cover 50 includes up to four sidewall sections 54 connected together and formed by core material 52 sandwiched by skins 51, 53. The bottom composite cover 60 includes a bottom section or portion that forms the central bottom surface of the battery enclosure. A portion of the sidewalls of the battery enclosure are formed by the sidewall section 64 of the bottom composite cover 60. In one or more embodiments, the bottom composite cover 60 includes up to four sidewall sections 64 connected together and formed by core material 62 sandwiched by skins 61, 63. Together, the sidewall sections 54, 64 of the top and bottom composite covers 50, 60 form the sidewalls of the battery enclosure.

Along the sidewalls of the battery enclosure, the sidewall sections 54, 64 of the top and bottom composite covers 50, 60 meet in an interlocking arrangement, in direct contact or close proximity if a seal is present therebetween, to form the battery enclosure area for storing battery units. The interlocking arrangement forms an interface defined in part by the shape of the perimeter surfaces for the sidewall portions of the top and bottom composite covers 50, 60. Sidewall section 54 of the top composite cover 50 has a perimeter surface 55 and sidewall section 64 of the bottom composite cover 60 has a perimeter surface 65 that faces perimeter surface 55. The perimeter surfaces 55, 65 of the top and bottom composite covers 50, 60 are not entirely flat surfaces, but rather have sections that can form angles, interface angles, with respect to one another to form a non-linear interface.

As described herein, the interface can be divided into sections defined by portions of the perimeter surfaces facing or meeting one another. The interface includes at least two sections, wherein each interface section includes an interface angle formed by the facing or meeting of mirroring portions of the perimeter surfaces 55, 65 of the top and bottom composite covers 50, 60. The at least two sections of the interface have different interface angles as compared to one another. The difference in interface angles between the first section and the second section can be any suitable degree, for example, in the range of 1° to 90°, 10° to 60°, or 20° to 50°. The interface can include more than two sections, for example, 3, 4, 5 or 6 sections. In one or more embodiments, at least two of the sections of the interface can have the same interface angle wherein the two sections having the same interface angle are not directly next to one another.

As shown in FIG. 3, interface 70 has three sections, a first section 71, a second section 72 and a third section 73. The first interface section 71 has an end facing the battery enclosure area and an opposite end that intersects with the second interface section 72. The first interface section 71 has an interface angle of 0°, or as shown a flat section parallel to the top and bottom surfaces of the battery enclosure. The second interface section 72 has an end that intersects with the first interface section 71 and an opposite end that intersects with the third interface section 73. The second interface section 72 has an interface angle that angles downward from the first interface section 71, for example, about 45°. The third interface section 73 has an end that intersect with the second interface section 72 and an opposite end that facing the environment surrounding the battery enclosure. The third interface section 73 has an interface angle of 0°, or the same as the first interface angle of section 71. In other embodiments, other interface sections can be included to the sections as shown in FIG. 3.

By including at least two interface sections that have different interface angles, the interface reduces the chance of material passing into or out of the battery enclosure area. For example, the various interface angles positioned in the interface forms an intricate pathway or barrier that prevents material from flowing into the battery enclosure. Thus, the interface pathway between the perimeter surfaces 55, 65 makes it difficult for debris, moisture, chemicals, liquids and the like to enter into the battery enclosure area. Preventing harmful materials from entering the battery enclosure ensures a more stable operating environment in the battery enclosure area.

The interlocking arrangement formed at the interface of sidewall sections 54, 64 further provides resistance against lateral movements of the top and bottom composite covers relative to one another. The inclusion of two or more differing interface angles in sections of the interface prevent the perimeter surfaces 55, 65 of the sidewalls sections 54, 64 from easily sliding along one another. This increase the rigidity of the battery enclosure against impacts that would otherwise force one cover to dislocate from its intended position and cause the battery enclosure area to be exposed to the surrounding environment.

As shown in FIG. 4, the interface can include a sealing material positioned between the perimeter surfaces 55, 65 of the top and bottom composite covers 50, 60. The sealing material can be any suitable material for forming an air-tight seal at the interface for further deterring any material from entering into or out of the battery enclosure area. For example, the sealing material can be an adhesive, a gasket, an elastomer material, a foam, and the like. The sealing material can be positioned at any point in the interface. For example, the sealing material can extend along the entire interface region or be selectively positioned in one or multiple interface sections. As shown, the sealing material 75 is positioned in the third interface section 73 near the outer surface of the sidewall of the battery enclosure.

The top and bottom composite covers 50, 60 can be secured together by any of the means above, for instance, a fastener, adhesive, rivet, etc. In one or more embodiments, the top and bottom composite covers 50, 60 can be secured together at or near the interface 70 area. As shown in FIG. 4, the interface 70 can extend outward from the exterior of the battery enclosure in the form of two monolithic sections, a top monolithic section 56 and a bottom monolithic section 66. The top and bottom monolithic sections, for example flanges, are free of core material and constructed from the respective skins 51, 52, 61, 63 of the top and bottom covers 50, 60. The monolithic sections or flanges herein can have a thickness in the range of about 1 mm to about 5 mm when devoid of core material. The monolithic sections 56, 66 form a border region, such as a flange or lip at an end area (e.g., a perimeter portion) of each composite cover 50, 60. The monolithic section 56, 66 can be a perimeter border, or a select portion thereof, for the top and bottom composite covers 50, 60. The monolithic flange section 56 of the top cover can rest against and contact the monolithic flange section 66 of the bottom cover to fit the covers together and provide stability and structural integrity to the enclosure.

An attachment device, fastener or component thereof can be molded into or onto the monolithic sections 56, 66 to accommodate attachment or anchoring to another structure, such as the frame or body of a vehicle or adjacent composite cover in the case of a multi-piece composite battery enclosure. As shown, the monolithic sections can 56, 66 can be riveted together, or alternatively apertures in each section can be aligned to accommodate a fastener for attaching the top and composite covers 50, 60 together. The use of fastener attachment component and the like can reduce the need for adhesives for securing the composite covers together or to other parts. In an alternative embodiment, the monolithic sections can be bound together with an adhesive material or an epoxy.

While various aspects and embodiments of the compositions and methods have been disclosed herein, other aspects and embodiments will be apparent to those skilled in the art. The various aspects and embodiments disclosed herein are for purposes of illustration and are not intended to be limiting, with the true scope and spirit being indicated by the claims.

1. A composite battery enclosure comprising:
a. a molded top composite cover comprising
i. a first monolithic flange section at the perimeter of the molded top composite cover, the first monolithic flange section comprising fibers embedded in a first polymer, the first monolithic flange section comprising a first surface and a second surface, and
ii. a first core positioned adjacent the first monolithic flange section, the first core sandwiched between a first top composite cover skin and a second top composite cover skin; and
b. a molded bottom composite cover comprising
i. a second monolithic flange section at the perimeter of the molded bottom composite cover, the second monolithic flange section comprising fibers embedded in a second polymer, the second monolithic flange section comprising a first surface and a second surface, and
ii. a second core positioned adjacent the second monolithic flange section, the second core sandwiched between a first bottom composite cover skin and a second bottom composite cover skin.

2. The composite battery enclosure of claim 1, wherein the first monolithic flange section is in contact with the second monolithic flange section.

3. The composite battery enclosure of claim 1, wherein the first monolithic flange section and the second monolithic flange section are both curved, and the first monolithic flange section is positioned inside the second monolithic flange section.

4. The composite battery enclosure of claim 3, wherein the first monolithic flange section is nested inside second monolithic flange section.

5. The composite battery enclosure of claim 1, wherein the first monolithic flange section forms the entire perimeter of the molded top composite cover.

6. The composite battery enclosure of claim 1, wherein the second monolithic flange section forms the entire perimeter of the molded bottom composite cover.

7. The composite battery enclosure of claim 1, wherein the first core of the at least one lateral beam is a honeycomb material.

8. A composite battery enclosure comprising:
a. a molded bottom composite cover comprising
i. a second core sandwiched between a first bottom composite cover skin and a second bottom composite cover skin;
ii. the second core forming a sidewall of the enclosure, the sidewall comprising an interior sidewall surface, a top sidewall surface, and an outer sidewall surface
b. a molded top composite cover comprising
i. a first core sandwiched between a first top composite cover skin and a second top composite cover skin, the first core comprising a reinforced area of increased thickness positioned adjacent sidewall formed by the second core of the molded bottom composite cover such that the reinforced area of increased thickness abuts against a portion of interior sidewall surface of the molded bottom composite cover and along the interface of the interior sidewall surface and top sidewall surface.

9. The composite battery enclosure of claim 8, wherein the reinforced area of increased thickness of the first core ends along a portion of the top sidewall surface.

10. The composite battery enclosure of claim 8, wherein the reinforced area of increased thickness comprises a curved section that overlies and rests against the sidewall of the molded bottom composite cover at the interface of the interior sidewall surface and top sidewall surface.

11. The composite battery enclosure of claim 8, wherein the first core of the molded top composite cover comprises lip section positioned between the reinforced area of increased thickness and a first monolithic flange section at the perimeter of the molded top composite cover.

12. The composite battery enclosure of claim 11, wherein the lip section has an average thickness less than the average thickness of the reinforced area and the lip section overlies the top sidewall surface of the molded bottom composite cover.

13. The composite battery enclosure of claim 11, wherein the lip section is secured to the top sidewall surface of the molded bottom composite cover with a fastener.

14. A composite battery enclosure comprising:
a. a molded top composite cover comprising
i. a first core sandwiched between a first top composite cover skin and a second top composite cover skin, the first core comprising a top portion and a sidewall portion, the sidewall portion of the molded top composite cover comprising a top composite cover perimeter surface;
b. a molded bottom composite cover comprising
i. a second core sandwiched between a first bottom composite cover skin and a second bottom composite cover skin, the second core comprising a top portion and a sidewall portion, the sidewall portion of the molded bottom composite cover comprising a bottom composite cover perimeter surface, the bottom composite cover perimeter surface facing the top composite cover perimeter surface;
c. an interface in the sidewall of the composite battery enclosure, the interface formed by the sidewall portion of the top composite cover meeting the sidewall portion of the bottom composite cover, wherein the interface comprises a first section and a second section, the first section comprising an interface angle different than an interface angle of the second section.

15. The composite battery enclosure of claim 14, wherein the interface angle of the first section of the interface is at least 10 degrees different than the interface angle of the second section of the interface.

16. The composite battery enclosure of claim 14, wherein the interface comprises a third section comprising an interface angle, the interface angle of the third section being different than the interface angle of the second section.

17. The composite battery enclosure of claim 16, wherein the interface angle of the third section is the same as the interface angle of the first section.

18. The composite battery enclosure of claim 14, wherein a sealing material is positioned at the interface between the bottom composite cover perimeter surface and the top composite cover perimeter surface.

19. The composite battery enclosure of claim 14, wherein the bottom composite cover perimeter surface comprises a bottom sidewall monolithic flange that extends outward from the sidewall portion and the top composite cover perimeter surface comprises a top sidewall monolithic flange that extends outward from the sidewall portion.

20. The composite battery enclosure of claim 19, wherein the top sidewall monolithic flange is fastened to the bottom sidewall monolithic flange.
